(19) United States
(12) Patent Application Publication
(10) Pub. No.: US 2008/0275733 A1
(43) Pub. Date: Nov. 6, 2008

(54) Method for evaluation of patient identification

(76) Inventors: Volker Schmidt, Moehrendorf (DE); Silke Grundmann, Nuernberg (DE); Hans Schull, Weisendorf (DE); Florian Kubo, Fuchsstadt (DE); Alexander Schonfeld, Forchheim (DE); David Wolfgang Eberhard Schmidt, Erlangen (DE); Dominic Pascal Schmidt, Dorfstr (DE)

Correspondence Address: BRINKS HOFER GILSON & LIONE, P.O. BOX 10395, CHICAGO, IL, 60610, US

(21) Appl. No.: 11/799,899

(22) Filed: May 3, 2007

(51) Int. Cl. G06Q 10/00; G06F 17/40

(52) U.S. Cl. 705/3

(57) ABSTRACT

A method and a software product is described for managing the evolution of changes and updates to a patient identification system. In a patient identification system, the data may have errors or inconsistencies which preclude automatic matching of the data for an input data record, representing a person being admitted to a hospital, with a patient object in a data base, the patient object representing a unique individual. The method includes identifying the input data records that cannot be automatically matched, and manually matching the records to objects. The manual steps are recorded and used to develop updates to the software product. The input data is again processed by the patient identification method and the amount of improvement in, or the error in, the association is used to determine when the updated software may be installed.

### TECHNICAL FIELD

The present application relates to a method of improving the accuracy of combining information from a plurality of heterogeneous data bases.

### BACKGROUND

To realize the sustainable efficiency required throughout all of the health care system, the entire process of providing service has to be optimized, from prevention, to diagnosis and treatment, and to rehabilitation and care. As a result, the barriers between the inpatient and outpatient sectors may need to be eliminated. Better integration of these two sectors would significantly improve the quality of care, improve transparency, and have significant potential for improving efficiency.

In Germany, for example, physicians in private practice have been communicating with other service providers using the network patient records of Soarian Integrated Care, a medical data management system available from Siemens AG (Munich, Germany). Once authorization is obtained from the respective patient, data and information such as admissions, discharge forms, and reports can be exchanged between the physicians and service providers taking part in the treatment. This type of communication is possible between private practices and hospitals, as well as within hospital chains. In addition, connections can also be established with other health care facilities, such as rehabilitation centers or pharmacies. All partners participating in the health care process can access this information at any time and use it as the basis for a more certain diagnosis and earlier, more effective treatment. The transitions between in-patient, out-patient, and rehabilitative care are coordinated better, and repeated examinations are reduced significantly. For hospitals, a timely connection to a referring physician represents a competitive advantage that helps to ensure the continued existence of the provider in the market place.

Implementing this type of integration concept on a national level creates significant potential for efficiency. The objective of this type of infrastructure is to make the patient's medical information available not only within the private practice or hospital, but also throughout the entire country. A comprehensive telematics infrastructure would first be required in order to design secure access to the required information, and to enable an electronic comparison of a prescribed medication or treatment with the individual electronic patient record, regardless of storage location. This would include accurate identification of the patient and data, including images and medical test results associated with the patient. In a national concept, an electronic health care card, for example, would serves as the uniform access key for the patient to central administrative and medical applications. The health care professional identity card would serve the same function for physicians and pharmacists. This would ensure maximum security for patient data while minimizing errors.

However, where complete systems integration cannot or has not been achieved, data which are sent from different systems (KIS, RIS, PACS, PVS, health insurance companies), either manually or electronically, need to be put together to make an object (such as a specific patient, a physician, or an institution). This requires recognizing that the same object is involved. This recognition should be automated as much as possible, consistent with the integrity of the source data and the possibility of error in forming the object data. Data identified from the different systems may appear different, for instance because names are not written out in full, some of the information is missing, or object-specific data change over the course of time.

The quality of the data varies, depending on the systems sending the data or on the type of data input process; for instance, repeated manual inputs involve a greater risk of error or deviations than data scanned in from a magnetic card, for instance.

Other sources of difficulty in data association arise when the object, particularly a person has moved, and the associated address and telephone number have changed. Further, there may be a misspelling of the name, or a variability such as the use of a shortened or “nickname”, or differing transliterations of names between languages, or the like. Each of the differences may create a mismatch between the data in the same data field for an object which is actually the same person. Similarly, as the number of such mismatches becomes large, the possibility that an automated program, not having sufficiently stringent criteria for matching, may misidentify a person increases, and this would be unacceptable from a quality and safety viewpoint.

Depending on the country and region, different algorithms for the matching (recognizing the similarity of data) may need to be considered, and must also be adapted to given local/project-specific conditions.

In an example, in the United States, a phonetic indexing system originally known as the Russell Soundex System (U.S. Pat. No. 1,261,167, issued on Apr. 18, 1918) was used to represent the sounded version of a written name, so that spelling variations are accommodated. For example the names “Smith” and Smyth” are coded with the same Soundex value. This system has evolved since being introduced, and is now known as the American Soundex System. However, this system does not adequately represent names, for example, from some European countries. In some applications, the Daitch-Motokoff Soundex System is used to render Germanic or Slavic names. Hence, when a person with an unusual surname (for the geographical area encompassed by the data base), or where the transliteration varies, the particular phonetic recognition system may fail to associate the name with the object.

In other example, a person providing a name for data entry may omit a middle initial, or vary the spelling of the name. More variability results from the use of non-standard forms of residence address. That is, a “Street” may be a “St.”, address numbers may be spelled out, and the like. In some countries, there are algorithmic programs that attempt to convert the non-standard representations of the address into a standardized form. One example is the US Postal Service CASS (Coding Accuracy Support System). A CASS-certified software program is required to match address having incorrect data fields to known addresses (address, city, state, postal code, and the like) and to correct and standardize the address data fields. However, even with this correction of the format and address data, the association of the address with a person is mitigated by the movement of people between different fixed addresses. An estimate of such movement is about 10-15% of the population each year.

Other representative data may also be used in the identification of the object, such as age, birth date, social security or other national identification number, and the like. These data would be typical of a hospital intake form or as used in a physician's office.

Nevertheless, the algorithms and procedures that may work in one country may be entirely unreliable in another country, due to differences in language structure, political organization, automation and the like. As a consequence, the introduction of a medical data records organization system which associates individual patients with patient objects into another country may result in difficulties in obtaining suitably reliable and efficient data association. A method of evolving improvements to the data merging software is needed to facilitate the process.

### SUMMARY

A method and software product is disclosed whereby new algorithms can be developed, tested and adapted for merging data in heterogeneous data bases.

The method includes the steps of creating a data base of existing patient objects, receiving input data records characterizing a patient as a patient object; executing a software product, embodied on a computer-readable medium, on a computer, the software product configuring the computer to associate input data records with patient objects; and, creating a first output file of input data records not associated with existing patient objects.

The method may further include the steps of displaying an input data record from the output file, manually attempting to associate the input data record with an existing patient object; and, recording the actions taken in attempting to associate the input data record with an existing patient object.

In another aspect, the method may further include preparing a software update to the software product based on at least an analysis of the recorded actions; retrieving the first output data file; executing the updated software product on the computer, the updated software product configuring the computer to associate input data records from the first output file with existing patient objects; and, creating an second output file of input data records not associated with existing patient objects.

In still another aspect, the method may include determining a quality measure of the improvement of the updated software product with respect to the software product; and, installing the updated software product to replace the software product when a expected the quality measure is achieved.

A software product is described, the product embodied in a computer-readable medium, to enable a computer system to perform a method of managing an patient identification system, the method comprising creating a data base of existing patient objects; receiving input data records characterizing a patient as a patient object; executing the contents of the computer-readable medium on the computer, the contents configuring the computer to associate input data records with patient objects; and creating a first output file of input data records not associated with existing patient objects.

In another aspect, the software product enables displaying a data record of the output file; manually attempting to associate the input data record with an existing patient object; and recording the actions taken in attempting to associate the input data record with a patient object.

In yet another aspect, the software product enables preparing a software update to the contents of the computer-readable medium, based on at least an analysis of the recorded actions; retrieving the first output data file, executing the updated contents of the computer readable medium on the computer, the updated contents configuring the computer to associate input data records of the first output data file with existing patient objects; creating an second output file of input data records not associated with existing patient objects; determining a quality measure of the improvement of the updated contents; and installing the updated contents on the computer readable when the quality measure meets a threshold value.

### BRIEF DESCRIPTION OF THE DRAWINGS

FIG. 1 is a flow chart showing the steps in a method of matching patient data with existing patient data in an object data base;

FIG. 2 is a flow chart showing the steps in a method of developing a software product update based on analyzing the manual steps in matching patient data not matched to the object data base by the method of FIG. 1; and

FIG. 3 is a flow chart showing the steps in a method of evaluating the software product update.

### DETAILED DESCRIPTION

Exemplary embodiments may be better understood with reference to the drawings, but these embodiments are not intended to be of a limiting nature. Like numbered elements in the same or different drawings perform equivalent functions.

The combination of hardware and software to accomplish the tasks described herein may be termed a platform. Where otherwise not specifically defined, acronyms are given their ordinary meaning in the art.

The instructions for implementing processes of the platform, the processes of the client application, the processes of a server and other functional elements may be provided on computer-readable storage media or memories. The instructions are commonly called a computer program, computer program product or software. Computer readable storage media include various types of volatile and nonvolatile storage media, such as a cache, buffer, RAM, flash, removable media, hard drive or other computer readable storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like. In an embodiment, the instructions may be stored on a removable media device for reading by local or remote systems. In other embodiments, the instructions may be stored in a remote location for transfer through a computer network, a local or wide area network or over telephone lines. In yet other embodiments, the instructions are stored within a given computer or system.

To support multiple users at geographically distributed locations, a web-based platform may be used with particular emphasis on the transmission, storage and retrieval of data sets. Where the term “web” or “Internet” is used, the intent is to describe an internetworking environment, including both local and wide area networks, where defined transmission protocols are used to facilitate communications between diverse, possibly geographically dispersed, entities. An example of such an environment is the world-wide-web (WWW) and the use of the TCP/IP data packet protocol, and the use of Ethernet or other hardware and software protocols for some of the data paths. Other proprietary data base protocols may also be used.

Herein, the term “patient” may also mean a physician, or an institution, unless specifically limited to the patient. Also an institution may be another health care professional, a doctor's office, a hospital, a medical laboratory, an insurance company, a governmental entity or the like, associated with the health care industry or profession.

In an aspect, input data records representing identifications and attributes of an object, such as a person, a physician, or a medical facility may be received from a plurality of sources. The data may be input manually such as by typing at a keyboard, writing using handwriting recognition software or the like, or may be input automatically be reading a magnetic card, bar code, or the like. The format and representation of such data may not be standardized for historical, commercial, institutional, legal, or other reasons; however, association of the input data with an object permits input data sets or other data related to patient objects of the plurality of entities to be linked, merged, or queried for access and updating. This problem is well known, for example in combining data from a number of sources to form a single mailing list. The simplest operation that is useful on such a merged list is to identify duplicate data entries. However whenever the data is not exactly the same, a simple approach fails. As an example, the use of a nickname instead of a given name, or the representation of a portion of a street address, such as “Avenue” as “Ave”. This is merely illustrative of the variety of problems which may need to be addressed in a patient identification system.

Decision rules may be developed either by analysis of the data or heuristic means to reduce the percentage of errors or lack or match in performing the association of data from various sources. Such rules, algorithms, or analytical tools may differ substantially depending on the type of data sets being merged, as well as the consequences of an error in the merging process or the identification of an object (e.g., individual patient) based on the merged data set. This is particularly true in the medical arts as incorrect diagnosis or treatment may have serious and irreversible consequences.

One means of merging algorithm development, validation and testing is to use a group of data sets, where the data in the data sets that belong together are known and, and the operation of the algorithm is checked to determine whether the algorithm performs the correct associations. A problem in the method is to obtain a large enough group of data sets of appropriate quality. Porting to a different environment (for instance, from an English-speaking region to a German-speaking region), a different type of object (for instance, from patients to physicians), or a different language or cultural structure is correspondingly complicated.

An existing baseline patient identification program may need to be adapted to accept input data from a new source, or in another language, or region. The baseline patient identification program will have a known effectiveness in processing data from and for which the baseline program was originally developed, and this may be measured as an error probability against a known test data set.

An aspect of the adoption of the patient identification program to a new environment is the use of a human to perform initial matching of the new input data sets with objects, optionally supported by the baseline algorithm. The system described herein may act as an “expert” system and tracks the decisions of the human in associating the input data sets with objects. Which input data sets can be matched to an existing object, which data sets represent new objects, and which data sets require manual clarification, and the method by which the appropriate matching data were found are observed. As patterns of activity are observed, the computer program instructions may be adapted either by writing new or modified algorithms, or by adaptive learning methods to replicate the human actions, without the work of the human being affected. That is, the human decisions are not overturned by the computer system, but are used when the computer system fails to find an appropriate match for the data. The computer decision process may be considered as identifying a input data record or data set for association with an object, based on the matching algorithms. The development system uses the existing assembly algorithms to identify candidate data for assembling into the object and simultaneously follows along with the decisions of the human.

When operating on the same set of input data records, an objective may be to develop algorithms such that the difference between the object defined by the human data analysis and the data merging program is minimized. The objective is to associate a same input data record with the correct patient object. So, instances where the data patient identification program does not achieve the same result as the human are identified and analyzed so that the computer program may be modified, retested, and adapted such that the computer result associates the same data with the object as a human would have done.

The development process is repeated until an adequate certainty that the correct associations between the input data records and the object have been achieved. Algorithms may be modified and adapted until such time as adequate certainty of association is attained, so that incorrect or failed association of the data sets is reduced to a value that is lower than a predetermined threshold. The validated updated patient identification program may then be released for use.

There still may be some circumstances where the computer program may not be able to associate a data set with a specific object, and this data may be output so that a human can analyze the data and determine the proper disposition of the data. Such a process may be considered as adaptation to a new environment or as routine maintenance of the computer program, and may also serve to identify changes in the quality of the input data being processed.

For the cases where the present computer program and parameters do not yield a suitable association of input data records with an object, further algorithms can optionally be tested and released if they prove suitable. For each algorithm, the setting parameters, the data fields used, the algorithm results, and the decisions of the human are stored in memory as a data set. The testing results with regard to one data set, a plurality of data sets, or all the data sets present in the system may be stored. The data sets relevant to the assessment of the algorithm can be exported and analyzed externally. Algorithms can themselves be implemented in learning fashion and be identified for release or automatically released when a defined correct identification rate is achieved. Data sets verified by the human can be used for a as reference data sets for testing of algorithm changes. Such data sets may be divided or combined to produce additional test data sets.

In this manner, the quality of the algorithms used for data merging to form objects can be tested before the actual use to ensure a known standard of accuracy, and the effect of changes to the data merging and patient identification algorithms can be identified. By maintaining such a retrospective data base, the performance baseline of the computer program may be evaluated objectively.

In an aspect, the performance may be evaluated prospectively. That is, the data merging program is configured so as to use the developed set of algorithms for the matching and object formation process. The algorithms are incorporated into the routine matching process. The results are measured prospectively. All the data are exported. In the exported system, all the matching decisions of the human are rescinded. The algorithms are then incorporated in the export system, and the decisions of the human are executed by machine. The algorithms are measured retrospectively using the reference data set standard.

In another aspect, the system and method may be considered to be a means of synthesizing metadata describing each object. The object may have data, such as images, medical test data, and the like stored in a plurality of data bases. Since the metadata associated with the records for the object in each of the data bases may be different due to, errors in data entry, incomplete data entry, or incompatibility of data descriptions, combining the data in the plurality of data bases may lead to miss-matched or unmatched data records. In the case of miss-matched data, test or image data for one patient may be used in the diagnosis of another patient. In the case of unmatched data, the data base system may report that a test has not been done, or that the test data cannot be found, so that the test may have to be performed again.

When data bases are to be combined, the object metadata would be intended to provide a series of attributes that can be used to define an object. Metadata provided by contributing data bases may be tested for a degree of similarity of values of the attributes between the object metadata and the metadata of the contributing data base. Where the degree of similarity is greater than a threshold value, the metadata of an object of a contributing data base may be associated with or bound to the object metadata. Where such an association cannot be made, then the metadata may be output for analysis by a human. The result of the human analysis may be used to modify the algorithm or weighting used in the similarity analysis.

When metadata from a contributing data base is associated with an object metadata, a query on the object metadata may enable data from the contributing data base to be retrieved.

In an example, an existing patient identification program may be used. The version of the program may have been developed for a country such as the United States, where the data bases of residence addresses are well managed, and where citizens have social security numbers. Standardization of the representation of the data in the data base may proceed reasonably successfully. In a circumstance where a patient appears for admittance to a hospital, personal data is obtained, which may include the social security number and current residence address and telephone number. Some of this data may be missing or incorrect, even when given directly by the person being admitted to the hospital.

Statistically, a small percentage of the data cannot be matched or merged automatically, and a human must intervene to analyze the discrepant data set and attempt to make the merge. These data represent algorithmic failures, and may be used in further research so as to improve the system. Another reason for a lack of match is that the patient is actually a new intake to the system.

When the patient identification system is to be used in another country, Unknownland (a proxy is used here so as not to suggest a particular country), the operation of the system may be compromised by differences in the spelling and pronunciation of names from that in the baseline country, by a different physical addressing scheme, the lack of a national identification number, or the like. Initial development of the adaptation of the patient identification system may be performed by accumulating a data base of patient identification information from a number of hospital facilities in Unknownland, and entering the data into the patient identification system. This set of data may be considered as the existing patient object data base. The system may be used to associate the individual input data-records with a patient object. A patient object is the set of data that is considered to validly represent the actual patient.

To the extent that each input data record does not meet the formatting requirements, or cannot be associated with another data set comprising the patient object, the input data record may be output to an output data file. This data file is analyzed, statistically, or manually if necessary, so as to understand the inadequacies of the algorithm in the new environment. The output data file may also analyzed by a human to best determine the appropriate object with which to associate the input data record. These actions are also recorded an analyzed so as to suggest changes to the software algorithms so that the process may be performed by the computer system. In some instances, the process may lead to the conclusion that the data is in proper form and has been analyzed correctly, and that the reason for a lack of match is that the patient does not have a representation object in the system: that is, this is a new patient. In such a circumstance, in practice, the patient object would be added to the existing data base. During a development process, however, the test data base may be left unchanged so as to provide a stable baseline. Alternatively, the new patient object may be added to the existing object data base, so that the changes to the software being developed may be tested against this data as well.

Changes to the patient identification algorithms may be designed and coded. This may include variants of the Soundex system, changes to the residential address correction software, and the addition or deletion of particular data elements or fields to the decision algorithms, which may include weighting of the elements being evaluated. The new algorithm is tested against the Unknownland existing patient object data base again, and the input data records that remain unmatched or uncorrected are output to a second output data file. The data is again analyzed with respect to the remaining unmatched data to determine if additional algorithmic changes are necessary to the software product so as to meet a quality and accuracy criteria. The possibility of false matches is also evaluated. That is, data records which appear to represent the same patient object are scrutinized for plausibility, so as to avoid the situation where an incorrect association would be made. This may occur with a much lower probability than the lack of a match, but an error resulting in an incorrect match is particularly significant in a medical context as and incorrect treatment may result, particularly in an emergency situation.

When the probability of correct association meets predetermined criteria, the new software may be released for actual use. The probability of correct association may be considered as a quality measure, and may be, for example, a percentage of input data records that remain unmatched, taking account of known new records. The maturity of the algorithms may be evaluated, for example, by the rate of decline in the percentage of unmatched input data records.

Inevitably, as mentioned above, there will be cases where the patient identification software system does not result in a match of the input data record with a patient object. Of course, one possibility is that this is a first-time patient. This may be determined during an intake interview, as where the patient is an immigrant, or an infant, or a visitor. In other circumstances, such mismatch may be an indication of fraud, or of an ineligible person.

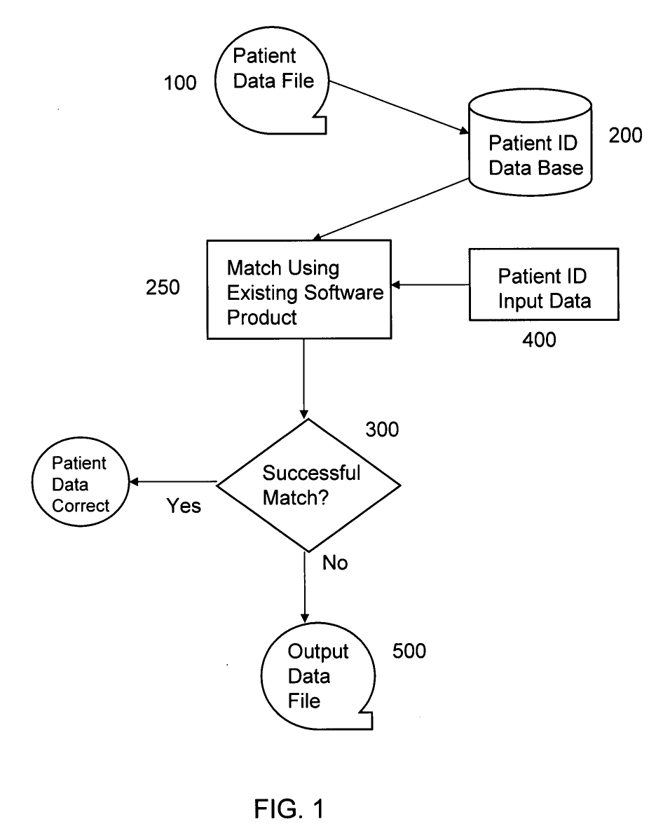

In an example, as shown in FIG. 1, the method includes creating a patient identification data base 200 using records of existing patients from a data file 100. When a new patient identification input 400 is obtained either by a data entry procedure or by retrieval of such data from another data file, an attempt (step 250) is made to match the new identification input 400 with the data in the identification data base 200. If a match has been made 300 (Yes), then the existing software product has performed the required function. However, if a match cannot be made then the 300 (No), then the data for which the matching or association process has failed is written to an output data file 500.

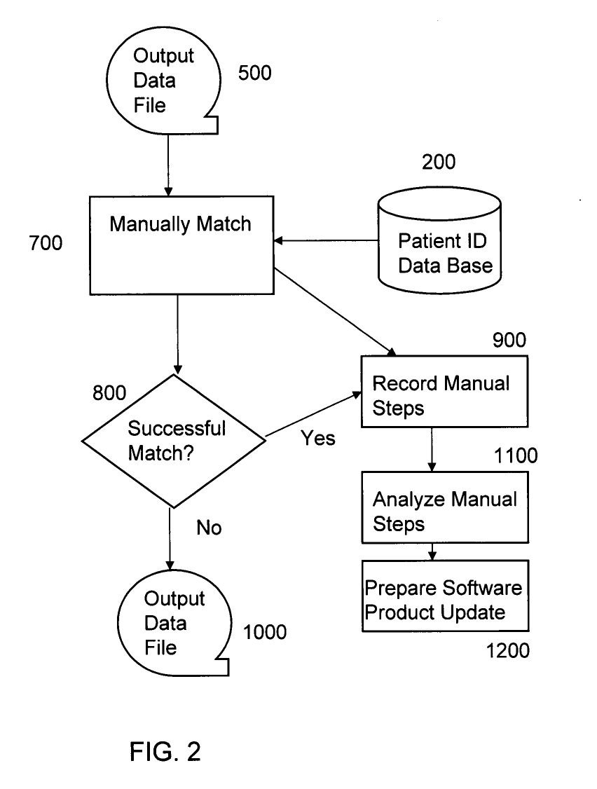

As shown in FIG. 2, the output data file 500 may be manually matched (step 700) to the patient records in existing patient data base. The manual actions are taken by a human and may be recorded 900 along with an indication of whether the match was successful or unsuccessful. The manual matching process may be performed as part of the normal data processing operation, and may be termed an “on-line” process, or the output data file may be analyzed once a sufficient number of examples are collected, which may be termed a “batch” process. A successful match 800 (Yes) may result when the association between the new record and a record in the existing data base can be made, or the operator decides that the input record may represent a new patient. The record of the steps performed in the manual association of input records with data from the existing patient data base may be analyzed (step 1100) to determine if changes to the software product are an appropriate step in improving the overall performance of the patient identification system. Should such changes be made, an updated software product is prepared (step 1200). Data that was not matched by either the use of the existing software product or by the manual method is written to a separate output data file 1000.

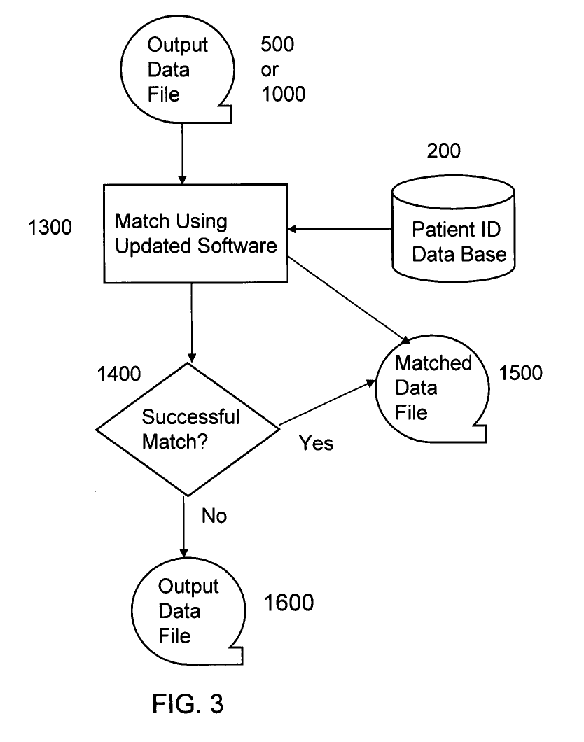

The new software product 1200 may be tested in several ways prior to being released for general use. As shown in FIG. 3, the output data file of failed associations 1000, may again be tested against the existing data base 200 to determine whether the software product update is more capable of identifying the records from the output data file 500 produced by the existing software product. It may also be used to process the output data file 1000, produced by the remaining unmatched records after the manual process. Such residual unmatched records may be the subject of further analysis.

The matched and new patient records may also be inserted in the patient data base 200 and the updated software product 1200 tested against a data base 200 having the new or manually matched data inserted therein, so as to demonstrate that the updated software product more successfully performs the associations.

While this example has used a patient record as an example of the object in the data base, the method is equally valid for improving the performance of the matching process for institutions, physicians, or other health care entities.

The methods disclosed herein have been described and shown with reference to particular steps performed in a particular order; however, it will be understood that these steps may be combined, sub-divided, or reordered to from an equivalent method without departing from the teachings of the present invention. Accordingly, unless specifically indicated herein, the order and grouping of steps is not a limitation of the present invention.

Although the present invention has been explained by way of the embodiments and examples described above, it should be understood to the ordinary skilled person in the art that the invention is not limited thereto, but rather that various changes or modifications thereof are possible without departing from the spirit of the invention. Accordingly, the scope of the invention shall be determined only by the appended claims and their equivalents.

What is claimed is:

1. A method of managing a patient identification system, the method comprising:
creating a first data base of existing patient objects;
acquiring input data records characterizing a patient as a patient object;
executing a software product on a computer, the software product configuring the computer to associate input data records with existing patient objects;
creating a first output file of input data records not associated with existing patient objects.
manually associating the input data records from the first output file with an existing patient object; and
recording the actions of manually associating the input data records with the existing patient object.

2. The method of claim 1, wherein the step of acquiring input data records includes one of receiving input data records or retrieving input data records stored in a second data base.

3. The method of claim 1, further comprising:
preparing an updated software product based on at least an analysis of the recorded actions.

4. The method of claim 3, further comprising:
retrieving the first output data file;
executing the updated software product on the computer, the updated software product configuring the computer to associate input data records of the first output data file with existing patient objects of the first data base; and
creating an second output file of input data records not associated with existing patient objects.

5. The method of claim 4, further comprising:
determining an error measure of the updated software product with respect to the software product.

6. The method of claim 5, wherein the error measure is the quotient of the number of records in the second output data file is the dividend and the number of records in the first output data file is the divisor.

7. The method of claim 5, further comprising:
installing the updated software product to replace the software product when the error measure is less than a predetermined value.

8. The method of claim 2, wherein the manually associated input data records are characterized as at least either new or existing patient objects, and adding the new patient objects to the first data base.

9. The method of claim 1, where the patient object is a physician object, the physician object representing an individual physician.

10. The method of claim 1, wherein the patient object is an institution object, the institution object representing an entity in a health care system.

11. The method of claim 10, wherein the institution object is a hospital.

12. The method of claim 10, wherein the institution object is a physician office.

13. The method of claim 10, wherein the institution object is a medical laboratory.

14. The method of claim 10, wherein the institution object is a health care expense reimbursement organization.

15. The method of claim 1, wherein the first data base is a one of plurality of data bases selected from a patent object data base, a physician object data base, or an institution object data base.

16. The computer-readable medium of claim 2, wherein the method further comprises receiving the input data records over the Internet.

17. The computer-readable medium of claim 1, wherein the method further comprises modulating the input data records on a carrier wave.

18. A computer-readable medium, the contents of which enable a computer system to perform a method of managing a patient identification system, the method comprising:
creating a first data base of existing patient objects;
receiving input data records characterizing a patient object;
executing the contents of the computer readable medium on the computer, the contents configuring the computer to associate input data records with patient objects;
creating a first output data file of input data records not associated with existing patient objects.
manually associating the input data records from the first output data file with an existing patient object; and
recording the actions taken in associating the input data records with the existing patient object.

19. The computer-readable medium of claim 17, wherein the method further comprises:
preparing a software update to the contents of the computer readable medium based on at least an analysis of the recorded actions.

20. The computer-readable medium of claim 19, wherein the method further comprises:
retrieving the first output data file;
executing the updated contents of the computer readable medium on the computer, the updated contents configuring the computer to associate input data records of the first output data file with existing patient objects of the first data base;
creating a second output file of input data records from the first output data file not associated with existing patient objects;
determining a error measure of the improvement of the updated contents; and
installing the updated contents on the computer readable medium when the error measure meets a threshold value.
